(19) United States
(12) Patent Application Publication
(10) Pub. No.: US 2010/0083328 A1
(43) Pub. Date: Apr. 1, 2010

(54) CLIENT CONFIGURATION AND MANAGEMENT FOR FAST CHANNEL CHANGE OF MULTIMEDIA SERVICES

(75) Inventors: Andrey Kisel, Maidenhead (GB); Dave Cecil Robinson, Woodsend Aldbourne (GB); Peter Beecroft, Highfields Caldecote (GB)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/566,090

(22) Filed: Sep. 24, 2009

(30) Foreign Application Priority Data
Sep. 24, 2008 (EP) 08290901.1

(51) Int. Cl. H04N 7/173

(52) U.S. Cl. 725/109

(57) ABSTRACT

A method of configuring and managing a user equipment client in an IPTV network (or cable or Internet TV) is disclosed, comprising installing a personalised service profile at the UE which is representative of fast channel change/retransmission service configuration data or other data available to the UE by virtue of at least its location, the service profile including a list of channels available for FCC/Retr and, for each channel, the address from which that service is achievable.

### BACKGROUND OF THE INVENTION

This invention relates to client configuration and management for fast channel change (FCC) and reliable delivery of IPTV, Internet TV, cable TV and similar services.

Broadcast channels in IPTV (internet protocol television) are typically transmitted using IP multi-cast techniques. Broadcast channels in Cable TV are typically transmitted using RF transmission techniques.

Early trials and deployment of IPTV contained a very limited set of VOD (video on-demand) titles, a small number of subscribers and were mainly used as a complimentary on-demand service to traditional broadcast methods. However, as IPTV becomes more successful and more widely deployed, it is required to provide many more VOD titles and broadcast channels, such as 5,000 VOD titles and hundreds of broadcast channels and each service provider may have many subscribers, extending well into the millions. Thus, it is now beginning to rival traditional broadcast or satellite systems.

A traditional advantage of IP systems is the existence of a return IP path, which offers means for real-time interactivity and control over the same infrastructure as service delivery. Similarly, there is a return path in Cable TV systems. However, in order to capitalise on the interactivity, the IPTV or cable TV service should most preferably offer better or at least the same user experience and quality of service as a more traditional services, eg analogue aerial broadcast TV channels.

Unlike traditional broadcasting, typically not all TV channels are immediately available to a client in an IPTV system, due to its multicast delivery nature. In addition, digital differential encoding is used. Essentially this means that the TV picture is sent as a key frame then a series of incremental frames which only include data which has changed from one incremental frame to another. After a number of incremental frames (typically 20) are transmitted a further key frame is transmitted and so on. This means that a user of client equipment when ‘tuning’ to a new channel suffers an inherent delay since the channel cannot begin to be properly displayed until a key frame is received. Thus, joining a stream is possible only at the key frames or at random access points (RAP) at the beginning of a fully encoded video frame.

The two factors described above contribute to relatively slow channel change times in IPTV systems.

In order to improve the channel changing experience, FCC units have been used. An FCC unit caches a sliding window of content (eg the last 30 seconds or last minute) of a broadcast channel. The content can later be delivered upon a channel change request from a client apparatus starting from an RAP, optionally at a higher than encoded bit rate. This can be done so that although a client initially receives an RAP which might be, say 30 seconds behind ‘real time’, the system then catches up by missing frames selectively so that after a relatively short period the user is watching effectively live transmission. This of course enhances the experience when the user is watching a live sports event or similar. Data from the FCC sever may be transmitted as a dedicated (so-called unicast) stream.

The FCC unit is typically pre-configured/provisioned with a set of BTV (Broadcast TV) channels (eg multi-class addresses) to be cached. In order to scale this approach, a distributed architecture has previously been adopted. This comprises a set of FCC units which are close to the network edge/access node, for example FCC units in a DSLAM. FCC functionality is described for example in ETSI TS183084 V2.1.1.

Quality of delivery (QOD) has similar requirements. Due to the unreliable nature of IP delivery, a loss of data packets can occur which can degrade viewing experience. In order to guarantee delivery of high value and consistent multimedia data, Retr (Retransmission) units have been developed. A Retr unit caches a sliding window of content on a broadcast channel. The missing data can later be delivered upon a client Retr request. In essence, if parts of the data received by the client are corrupt or incomplete it can request retransmission (Retr) of these.

The distributed architecture of a typical FCC/Retr system, together with a large number of units in the network edge, regional variations in a channel list, local variations in channel popularity and variations of channel popularity over time, requires a special approach to deploying a FCC/Retr system. When we say FCC/Retr unit (or server) we imply that the server can provide either FCC service or Retr service or both.

The FCC and Retr units can be combined to make a single FCC/Retr unit.

User equipment (eg an IPTV set-top box) is typically required to be preconfigured with a number of parameters for FCC/Retr service. These may include:
channels, for which FCC service is supported,
channels, for which Retr service is supported,
access details of access points to request either of services: FCC or Retr,
service configuration parameters for either of services such as local client buffer sizes, minimum line bandwidth or other data.

It should be noted that the availability of FCC or Retr in a particular network does not automatically guarantee service at the user equipment (UE). This is because the UE may not have the required service capabilities or the actual Internet connection (eg a DSL line) may not be of sufficient bandwidth or quality to deliver a particular service. This all needs to be taken into account during UE provisioning. Management of this client population becomes even more complicated when service providers have to take into account a distributed and often hierarchal FCC/Retr architecture, the large number of channels available, some of which may well not be available for FCC and/or Retr, regional and local variations in availability and popularity of channel and variability of channel popularity over time.

### DESCRIPTION OF THE PRIOR ART

A presently available system is Microsoft™ TV:

http://www.microsoft.com/tv/default.mspx

http://www.ixiacom.com/products/display?skey=aptixia_ixload_ms_iptv

http://www.microsoft.com/msft/download/Transcripts/FY06/ChristineHeckart09200 6.doc.

Microsoft TV uses manual static provisioning via an IPTV platform to configure an FCC/Retr unit known as a distribution server (D server). D servers are typically employed together in a local office called a branch. A system operator is required to manually configure each D server with a list of channels. The D server caches the channels and can later deliver them via proprietary means upon a channel change request to a client (user equipment—UE). The platform exposes channels supported by each D server to the client.

In this approach, D-servers are shared among all branch customers. This however means that the content is cached further away (in terms of the network) from the UEs. Therefore, optimisation of network usage by caching most popular channels at a network access point (eg in a DSLAM) cannot be performed. Neither can the caching of less popular channels higher up the network be performed (for example in a router some distance from the UE) or indeed other desirable functions such as factoring network location of the UE into the usage map, factoring local variations of channel popularity over time and correlating between local popularity and a recommendation engine.

Any manual mapping of a service to a D-server instance increases the probability of a human error.

The present invention arose in an attempt to provide an improved system.

### SUMMARY OF THE INVENTION

According to the present invention, in a first aspect, there is provided user equipment (UE) of an IPTV, cable or Internet TV data network, the UE comprising means for self-discovery and management of a personalised service profile including Fast Channel Change/Retransmission (FCC/Retr) service configuration data available to the UE by virtue of at least its location and/or capabilities and/or line capabilities and for storing and using this profile for IPTV service.

In addition to the location other factors such as UE capabilities, line capabilities can be factored into generation of the service profile.

Preferably, the profile generated is dynamically variable over time, to take into account factors such as varying channel popularity, local popularity variations, new UE capabilities, new line capabilities (i.e. upgrade in DSL line speed) or other factors.

The user equipment may be adapted to self-discover and manage the service profile with information supplied by a service configuration server (SCS).

In a further embodiment, the UE is part of a network including a service configuration server (SCS) and one more FCC/Retr units.

The invention further provides a network comprising a UE as described, a service configuration server and one or more fast channel change/retransmission (FCC/Retr) units, the UE being enable to install service profiles from the SCS including address and channel data of channels available at the local FCC/Retr unit or other remote units.

The invention further provides a method of configuring and managing a user equipment (UE) client in an IPTV network, cable or Internet TV network, comprising installing a personalised service profile at the UE which is representative of channels or data available to the UE by virtue of at least its location, the service profile including a list of channels available and, for each channel, an address from which that channel is retrievable, including Fast Channel Change/ Retransmission (FCC/Retr) configuration data.

In addition to the location other factors such as UE capabilities or line capabilities for example can be factored into generation of the service profile.

The FCC/Retr profile retrieved by the server (typically a service configuration server (SCS)) may contain data representative of a plurality of channels, pointers to local or remote FCC/Retr units provided for service for these channels and optionally configuration information.

The profile is specific to the determined network location.

In preferred embodiments, the method includes automatic transmission of service profile changes.

The present invention provides, amongst other advantages:

a) Automated configuration of an FCC/Retr client taking into account location, user profile (eg UE capabilities), line capabilities and/or other factors;

b) Network optimisation and automated mapping of network optimisation in the configuration by:
i) caching of most popular channels at the network access point (eg in a DSLAM, last mile),
ii) caching of less popular channels higher up the network (eg in a router, available at the 2nd or 3rd miles, in core networks) or otherwise provided ‘higher up’ the network,
iii) personalising FCC/Retr service to the client location,
iv) factoring local variations of channel popularity over time during personalisation,
v) factoring in addition User profile (eg UE capabilities), line capabilities and other factors, and
v) correlating between local popularity and a recommendation engine.

Embodiments of the invention will now be described, by way of example only, with reference to the accompanying drawings, in which:

### DESCRIPTION OF THE DRAWINGS

FIG. 1 shows a schematic network for IPTV service.

### DESCRIPTION OF EMBODIMENT OF THE INVENTION

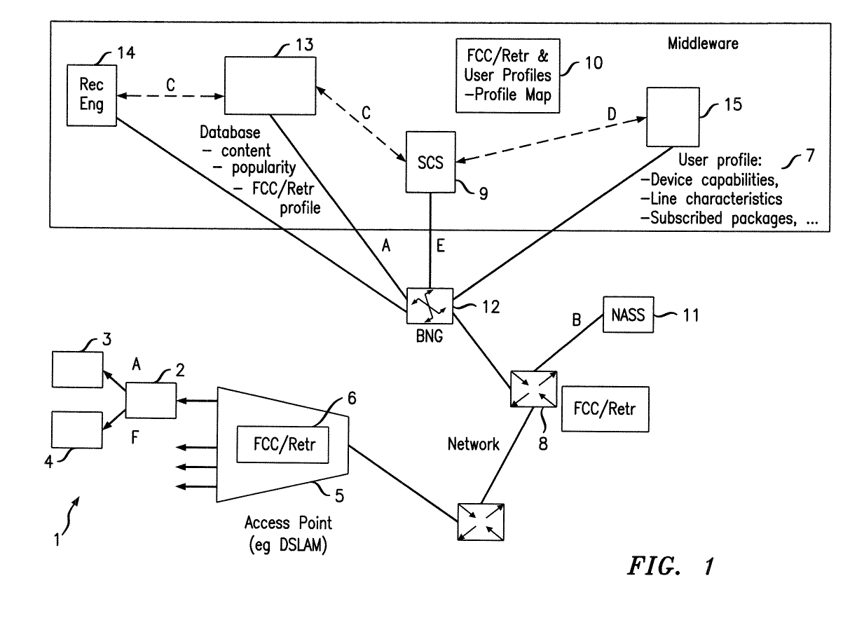

FIG. 1 shows an embodiment of a client self-discovery and management architecture. User equipment 1 typically comprises a set-top box/TV3 (shown together), a residential gateway (eg DSL modem) 2 and perhaps also a personal computer 4. In the fullness of time, it might be expected that two or more of these components will be combined into single units. In a locality (eg Maidenhead, Watford, South West London, etc) a number of such UEs are connected to an access point (AP) 5 such as a DSLAM (digital subscriber line access module) which includes a local FCC/Retr unit 6. In a similar alternative embodiment an external FCC/Retr unit can be collocated with several access points (DSLAMs). The FCC/Retr unit is adapted to cache a number of channels which are to be available to the connected UEs as FCC and/or Retr channels. Each UE is connected to the access point via, for example, an ADSL line, cable or other Internet network access means.

The AP 5 provides access to the Internet and to IPTV middleware 7. One or more further FCC/Retr units 8 are located up the network (eg in a router or collocated with a router). A service configuration server (SCS) 9 provides service in known manner and has access to a list of service profiles (13), and user profiles (15), and can derive a personalised service profile (location based profile map shown generally as 10) for each UE. SCS also has access to a network attachment subsystem (NASS) 11. The SCS connects to the FFC/Retr via a broadband network gateway (BNG) 12 and is connected to a database 13 of service profiles. The database 13 contains a topology of FCC/Retr units, content packages, and other service metadata, which may include historic usage metadata to determine popularity of the services and channels. The SCS is further connected to a recommendation engine 14 and to an IPTV middleware database 15 which contain user profiles. These profiles may be external, eg obtained from user profile server function (UPSF), Home Subscriber Server (HSS) which are well known in themselves. They may alternatively be internal to the IPTV middleware 7. These include data such as device capabilities of the user, line characteristics (eg bandwidth, quality of deliver/service and so) and details of packages the individual users subscribe to.

When the client UE 2 is first booted-up, a service profile can be loaded. Only mal identification information is required to boot strap and manage FCC/Retr service at the client. This minimal information can include client network identification (eg the IP address of the UE) and this can be obtained via DHCP (dynamic host configuration protocol). An example of the steps for boot-strapping the service are as follows, and are illustrated schematically by letters in the figure.
STEP A An FCC/Retr client at the user equipment 3 supplies its network identification (eg IP address) to the SCS 9.
STEP B The SCS 9 retrieves the location of the UE 3 using supplied network identification from NGN_NASS. It may, however, use alternative means for this such as from local tables and/or maps.
STEP C The SCS finds a user profile for the supplied network identification from the user profile database 10.
STEP D The SCS 9 finds a FCC/Retr service profile corresponding to the particular location of the UE from the service database 13. The SCS can also request other service profiles, eg service packages, to obtain channels to which the user is subscribed. The FCC/Retr profile itself is derived from the service metadata available in the platform (such as FCC/Retr topology and business rules for load balancing), location specific metadata (network location of the originating request), popularity and optionally from the recommendation engine 14.
STEP E The SCS maps (generates) a location specific FCC/Retr service profile to the user profile to create a personalised FCC/Retr service profile. This basically provides data specific to the UE of which channels will be available to the UE as FCC/Retr channels and the local or remote address where the channels are retrievable from for each channel. The personalised FCC/Retr service profile can include multiple addresses in order to provide service resilience, ie when one of the units fails. A preference order (i.e. hierarchy) may be applied to the addresses.
STEP F The personalised FCC/Retr service profile now generated is then received by the UE 2. This may be done by a pull or push mechanism.

The SCS will of course provide the same mechanism for many UEs.

The SCS is then arranged to either periodically or occasionally check for updates to the profile. This may either be done automatically or manually. In an automatic method, changes appropriate to local circumstances are noted. For example, if a rise in channel popularity is detected (by means of detecting a rise in requests for that channel) then this channel can be automatically added to the profile, and perhaps added to the list of FCC/Retr channels which are locally cached for fast retrieval and reliable delivery. This may particularly happen if a popular sports event starts being broadcast or if a news event breaks. Any profile changes effecting the unique FCC/Retr profile are propagated to the

UE via a push or pull mode and many such propagation methods are in themselves known.

Fast Channel Change (FCC) functionality is an extension of ‘channel change’ ability aimed at reducing channel change times because, as described above, switching between two broadcast channels (multicast flows) is typically slow. A first step of FCC requires the UE to initially request a dedicated (unicast) stream for a newly selected channel from a dedicated server in the network. This stream is often delivered, as described, at a higher than normal bit rate in order to fill client buffers quickly. A second step of FCC in embodiments is for the UE to switch from the dedicated unicast to a broadcast (multicast) channel and to follow normal IPTV ‘channel change’ functionality.

In order to use FCC, the UE may need to be capable of performing both the above steps. That is, it firstly needs to know the location (address) of the dedicated server (FCC/Retr server) in the network to initially deliver each broadcast channel in unicast, and to know which dedicated server supports which broadcast channels in unicast. The UE also needs to have the capability of receiving a unicast channel and to be able to support, via a suitable communications line a higher bit rate for the unicast FCC stream. The UE sets up and receives the unicast FCC stream from the server.

The UE also needs to know the location (second address) of a common broadcast channel (ie multicast). It then needs the ability to be able to switch from the unicast stream to the common broadcast (multicast) channel.

The functionality whereby the UE knows the location of the dedicated FCC server and possibly secondary FCC server, and has the capability of receiving unicast channels, the capability of setting up and receiving unicast FCC streams from the FCC server and to be able to use, a communications line supporting a higher bit rate represents a specific types of FCC functionality for which the UE needs to discover the configuration and data pertinent to this is part of the self-discovered and managed personalised profile which the UE is provided with.

A communication line capable of supporting the higher bit rate for the unicast FCC stream will be required.

A typical service profile might contain the following data

{Id—Description—Channel—Master FCC IP (can be shared)—Master Retr IP (can be shared)—FCC buffer—Retr buffer—Other}

For example, a profile may be:
1.1.1.1: Bob's STB—BBC1—192.1.1.1—192.10.1.1—8 MB—4 MB—Other
BBC2—192.1.1.1—192.10.1.1—8 MB—4 MB—Other
BBC3—105.5.5.5—10.6.5.5—4 MB—2 MB—Other
London News (could be ID)—10.5.5.5—10.6.5.5—4 MB—2 MB—Other

In the above, the ID of the service profile is 1.1.1.1. The description is ‘Bob's STB’. Thus is unique to, and personalised for, a particular UE at a particular location. The profile then lists all the channels available, such as BBC1, BBC2, BBC3 and so on. In this case, both BBC1 and BBC2 are available from local FCC unit address 192.1.1.1 and the Retr from local Retr unit 192.10.1.1. The FCC buffer available for FCC data is eight megabytes and for Retr data is four megabytes. This is the size of the buffer required at the UE 2. Other data might additionally be provided.

BBC3 on the other hand is obtainable from a different address and this might be a FCC/Retr unit 8 which is higher up the network and which is shared between many more subscribers. This could reflect the fact that BBC3 does not have regional variations whereas BBC1 and BBC2 have regional variations and so will be stored more locally. Also, because BBC 1 and BCC2 (in this example) are more popular these are locally stored and available as FCC/Retr channels since the user is more likely to want these and to want them quickly and may be happier to wait awhile to receive BBC3 for example.

Whereas in previously known solutions each FCC/Retr client is assigned to a static configuration so that network location is not taken into account and all D-servers are shared between branch clients, in the present invention the client index is associated with a unique FCC/Retr service profile which can be unique to that one particular client/UE. This takes into account network location and also enables the profile to be dynamically altered taking into account popularity, user profiles, recommendations, local ethnic/cultural, age variation and many other types of variables. A larger number of service profiles can be supported.

In summary, the invention enables automatic configuration of an FCC/Retr client taking location into account. In addition to the location other factors such as UE capabilities, line capabilities can be factored into generation of the personalised FCC/Retr service profile. It enables network optimisation by caching most popular channels at a network access point such as DSLAM. It also enables less popular channels to be cached higher up a network such as in the router 8. Furthermore, the service can be personalised to a particular client and local variations of channel popularity over time and recommendation can easily be taken into account.

Methods according to the invention may be applied both to traditional IPTV and also to Internet and cable TV systems.

1. User equipment (UE) of an IPTV, cable or Internet TV data network, the UE comprising means for self-discovery and management of a personalised service profile including Fast Channel Change/Retransmission (FCC/Retr) service configuration data available to the UE by virtue of at least its location and/or capabilities and/or line capabilities and for storing and using this profile for IPTV service.

2. User equipment as claimed in claim 1, wherein the UE is adapted to store the location of a dedicated FCC/Retr unit and is capable of receiving a unicast channel from said unit.

3. User equipment as claimed in claim 1, adapted such that the profile stored is dynamically variable over time.

4. User equipment as claimed in claim 1, adapted to self-discover and manage the service profile with information supplied by a Service Configuration Server (SCS) connected to one or more databases and/or information sources.

5. User equipment as claimed in claim 1, wherein the UE is adapted to store the address of one or more FCC units and to receive channels from said units at a higher bit rate than other channels.

6. A network comprising at least one UE as claimed in claim 1, a Service Configuration Server (SCS) and one or more Fast Channel Change/Retransmission (FCC/Retr) units, the UE being able to receive service profiles from the SCS including address and channel data of channels available at the FCC/Retr unit.

7. A method of configuring and managing a user equipment (UE) client in an IPTV network, cable or Internet TV network, comprising installing a personalised service profile at the UE which is representative of channels or data available to the UE by virtue of at least its location, the service profile including a list of channels available and, for each channel, an address from which that channel is retrievable, including Fast Channel Change/Retransmission (FCC/Retr) configuration data.

8. A method as claimed in claim 7, wherein the personalised service profile takes into account UE capabilities and/or line capabilities.

9. A method as claimed in claim 7, wherein the personalised service profile installed at the UE includes the address of one or more FCC/Retr units.

10. A method as claimed in claim 9, wherein the UE has the capability of receiving unicast channels from one or more FCC/Retr units and to set up and receive said channels.

11. A method as claimed in claim 7, wherein the service profile for each channel indicates the address of an FCC/Retr unit for a channel if available.

12. A method as claimed in claim 7, wherein, to install the profile, the method includes the following steps:
a) the UE supplies data representative of its network address to a server;
b) the server retrieves the location of the UE and identifies a FCC/Retr profile corresponding to this location;
c) the server maps this profile to the user profile;
d) a service profile adapted to the capabilities of the user if desired; and
e) the service profile is passed to the UE, and the UE installs it and thereby is provided with a service profile.

13. A method as claimed in claim 12, wherein the FCC/Retr profile in step (b) comprises data representative of FCC/Retr channels available at the location.

14. A method as claimed in claim 12, wherein the profile of step (c), including data representative of UE capabilities, subscribed packages and/or capabilities of the network connection from the UE.

15. A method as claimed in claim 12, wherein the service profile contains, for each channel, an address for a local or remote FCC/Retr unit for service of that channel.

16. A method as claimed in claim 12, wherein the server profile contains buffer sizes required for each channel.

17. A method as claimed in claim 7, wherein the personalised service profile includes multiple addresses for FCC/Retr service and their preferential order.

18. A method as claimed in claim 7, wherein the central server is adapted to periodically vary the profile to provide the new profile to the UE.

19. A method as claimed in claim 18, wherein the central server determines variations in any one or more of channel availability and data pertinent to the locality, user profile, subscriber content pertinent each unique UE, channel popularity and uses these to determine a varied service profile.
